(19) United States
(12) Patent Application Publication
(10) Pub. No.: US 2026/0219976 A1
(43) Pub. Date: Jul. 30, 2026

(54) INFORMATION PROCESSING APPARATUS, INFORMATION PROCESSING METHOD AND STORAGE MEDIUM

(71) Applicant: KABUSHIKI KAISHA TOSHIBA, Kawasaki-shi Kanagawa (JP)

(72) Inventors: Taichi FUKAWA, Kawasaki Kanagawa (JP); Jumpei ANDO, Yokohama Kanagawa (JP); Wataru WATANABE, Koto Tokyo (JP); Takayuki ITOH, Kawasaki Kanagawa (JP)

(73) Assignee: KABUSHIKI KAISHA TOSHIBA, Kawasaki-shi Kanagawa (JP)

(21) Appl. No.: 19/439,592

(22) Filed: Jan. 5, 2026

(30) Foreign Application Priority Data
Jan. 6, 2025 (JP) 2025-001826

(51) Int. Cl. G06F 11/07

(52) U.S. Cl. CPC G06F 11/0775; G06F 11/0769

(57) ABSTRACT

According to one embodiment, an information processing apparatus is configured to assist abstraction tasks for creating abstracted data from reference data. The information processing device includes a processor. The processor is configured to create input candidates indicating candidates for data that needs to be input to create the abstracted data based on the reference data, create basis information representing basis for which the input candidates should be input to create the abstracted data based on the reference data, and output the input candidates and the basis information.

### CROSS-REFERENCE TO RELATED APPLICATIONS

This application is based upon and claims the benefit of priority from Japanese Patent Application No. 2025-001826, filed Jan. 6, 2025, the entire contents of which are incorporated herein by reference.

### FIELD

Embodiments described herein relate generally to an information processing apparatus, an information processing method, and a storage medium.

### BACKGROUND

Generally, a task of creating abstracted data (hereinafter referred to as abstraction task) by abstracting referenced data (hereinafter referred to as reference data) is performed by a user. The abstraction task includes, for example, inputting a portion of data (information) extracted from the reference data according to a predetermined format into fields possessed by the abstracted data.

Note that, in a case where the reference data is, for example, a trouble report recording a trouble related to the manufacturing of a product that occurred at a manufacturing site for that product, a trouble case created from such a trouble report correspond to the abstracted data.

However, in a case where a document structure of the reference data does not correspond one-to-one with the fields of the abstracted data (i.e., in a case where the formats differ), the abstraction task performed by the user becomes difficult. Therefore, a mechanism to assist the user in performing the abstraction task is required.

### BRIEF DESCRIPTION OF THE DRAWINGS

FIG. 1 illustrates an example of an abstraction task assumed in an embodiment.

FIG. 2 is a block diagram showing an example of a functional configuration of an information processing apparatus.

FIG. 3 shows an example of a configuration of an input support information creation module.

FIG. 4 shows an example of a hardware configuration of the information processing apparatus.

FIG. 5 is a flowchart showing an example of a processing procedure of the information processing apparatus.

FIG. 6 shows an example of reference data.

FIG. 7 shows an example of abstracted data.

FIG. 8 shows an example of a data input screen.

### DETAILED DESCRIPTION

In general, according to one embodiment, an information processing apparatus is provided that assists in abstraction tasks for creating abstracted data abstracted from reference data. The information processing apparatus includes a first creation module, a second creation module, and an output module. The first creation module creates input candidates indicating candidates for data that needs to be input to create the abstracted data based on the reference data. The second creation module creates basis information representing the basis for which the input candidates should be input to create the abstracted data based on the reference data. The output module outputs the input candidates and the basis information.

Various embodiments will be described with reference to the accompanying drawings.

An information processing apparatus according to the present embodiment has a function of assisting a user in an abstraction task when creating abstracted data by abstracting reference data.

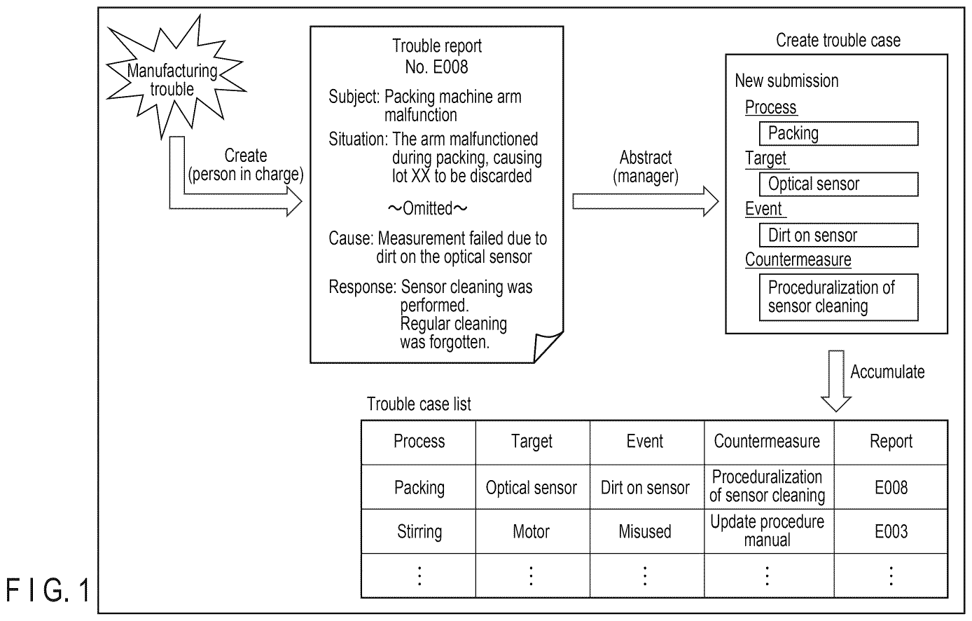

Here, with reference to FIG. 1, an example of the abstraction task assumed in the present embodiment will be described. Here, a case is described in which a trouble case is created based on a trouble report that records a trouble that occurred in a manufacturing site of a product, for example, regarding the manufacturing of that product. Note that the trouble report is an example of reference data, and the trouble case is an example of abstracted data.

As shown in FIG. 1, in a case where a trouble occurs at a manufacturing site, for example, a person in charge of manufacturing the product creates a trouble report. Note that the trouble report is data in a format (document data) created by, for example, describing in text each situation from the occurrence of the trouble to the response to that trouble.

A manager responsible for products manufactured at the manufacturing site (quality manager) or a manager directing the manufacturing process (manufacturing manager) refers to the trouble report, grasps its contents, and then performs an abstraction task. The abstraction task corresponds to a task of abstracting the trouble report to conform to the format (structure) of the trouble case.

In the example shown in FIG. 1, during the abstraction task, the manager must, for instance, confirm the contents of each item, such as a process, a target, an event, and a countermeasure, from the trouble report and input data corresponding to the confirmed contents into predetermined fields prepared in advance. Trouble cases created by performing such abstraction task are accumulated and can be utilized as a trouble case list for failure mode and effects analysis (FMEA), etc.

However, the aforementioned trouble reports may be created by a different person in charge each time a trouble occurs. For example, the document structure of the trouble report and the fields into which data is entered to create the trouble case may not correspond one-to-one (i.e., the format of the trouble report is not standardized). Also, the wording used in trouble reports may often vary depending on the person in charge creating them. Furthermore, trouble reports often include a large amount of data that is unnecessary for abstraction (i.e., creating trouble cases).

Therefore, during the abstraction task, a manager needs to search for a relevant section from the trouble report and input data for each field (item of the trouble case) included in the trouble case. Additionally, tasks such as generalizing the descriptions in the trouble report or consolidating duplicate entries may be necessary. Such abstraction task places a significant burden on managers.

In the present embodiment, to reduce the aforementioned burden on managers, an information processing apparatus is described that assists the manager in the abstraction task (data input task for creating abstracted data). Note that, in the following description, the manager performing the abstraction

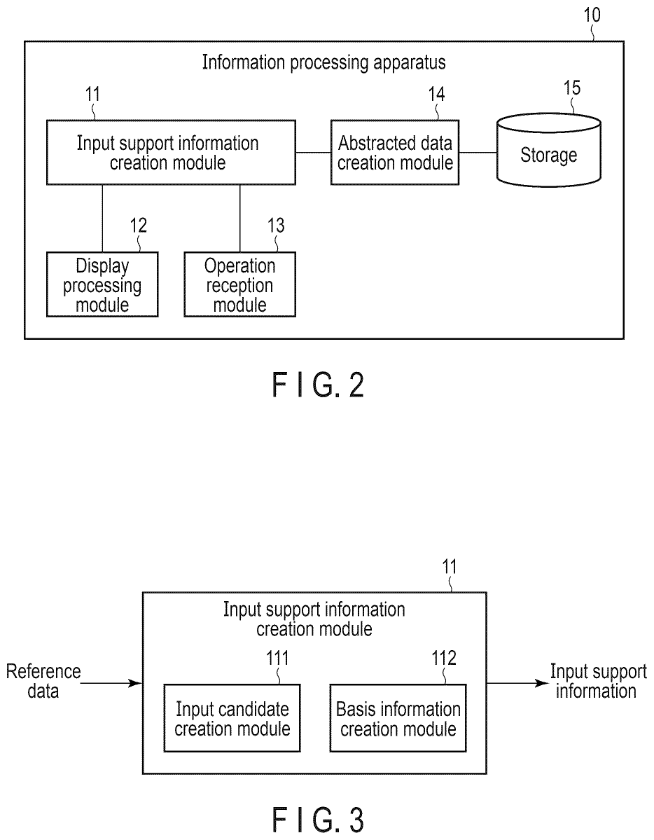

FIG. 2 is a block diagram showing an example of a functional configuration of the information processing apparatus according to the present embodiment. As shown in FIG. 2, an information processing apparatus 10 includes an input support information creation module 11, a display processing module 12, an operation reception module 13, an abstracted data creation module 14, and a storage 15.

The input support information creation module 11 creates input support information based on the aforementioned reference data. Note that the input support information corresponds to information for assisting in the aforementioned data input task for creating abstracted data (i.e., the abstraction task). Details of the input support information will be described later.

The display processing module 12 executes processing to display the input support information created by the input support information creation module 11. In other words, the display processing module 12 creates, for example, a screen (content) on which the input support information is drawn and displays that screen.

The operation reception module 13 accepts user operations on the screen (input support information, etc.) displayed by the display processing module 12.

The abstracted data creation module 14 creates abstracted data based on the input support information created by the input support information creation module 11 and the user operations received by the operation reception module 13. The abstracted data corresponds to data created, for example, by inputting a portion of the aforementioned reference data into predetermined fields. In other words, abstracted data can be said to be data including a portion of data extracted from the reference data.

The abstracted data created by the abstracted data creation module 14 is stored, for example, in the storage 15. The storage 15 accumulates, for example, abstracted data created in the past, and this storage 15 configures an abstracted database.

Note that while FIG. 2 describes the information processing apparatus 10 as including each of the modules 11 to 15, this information processing apparatus 10 may also have a configuration where some of the modules 11 to 14 and the storage 15 are omitted. Specifically, the information processing apparatus 10 may, for example, include only the input support information creation module 11, with the other modules 12 to 14 and the storage 15 being arranged in external devices of the information processing apparatus 10.

Furthermore, while the information processing apparatus 10 is assumed to be realized as a single device, it may also be realized as an information processing system realized by a plurality of devices.

FIG. 3 shows an example of a configuration of the input support information creation module 11 shown in FIG. 2. As shown in FIG. 3, the input support information creation module 11 includes an input candidate creation module 111 and a basis information creation module 112.

Here, as described above, the abstract data is created, for example, by inputting a portion of the reference data into a predetermined field. The input candidate creation module 111 creates input candidates indicating candidates for data that needs to be input to create the abstract data based on the aforementioned reference data. The input candidate creation module 111 creates input candidates, for example, by extracting a portion of the reference data (extracting a portion of the data from the reference data).

The basis information creation module 112 creates basis information representing the basis for which the input candidates created by the input candidate creation module 111 should be input to create the abstracted data. The basis information created by the basis information creation module 112 (i.e., basis information with respect to the input candidates) corresponds to information for the user to determine whether or not to input the input candidate to create the abstracted data (i.e., information that assists in selecting the input candidates).

Here, as mentioned above, in a case where the reference data is document data, the input candidates are created based on, for example, character strings, etc., described in the document data. In this case, the basis information creation module 112 creates basis information by, for example, analyzing the description state of the input candidate in the reference data.

Note that the basis information may be created based on, for example, classification results, etc. for the input candidates, or may be created by integrating the analysis results of the description state of the input candidates and classification results for the input candidates.

The input candidate created by the input candidate creation module 111 and the basis information created by the basis information creation module 112 are output from the input support information creation module 11 as the aforementioned input support information.

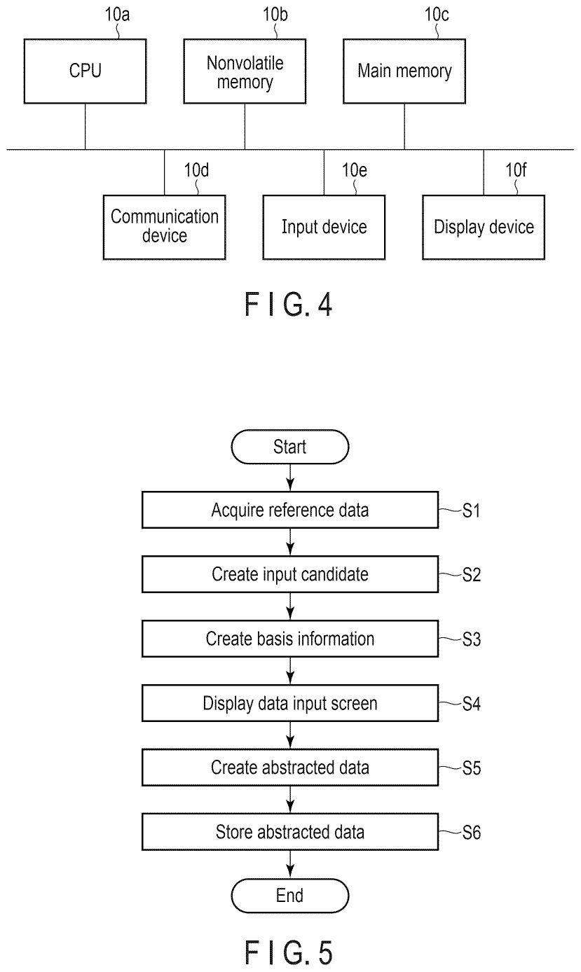

FIG. 4 shows an example of a hardware configuration of the information processing apparatus 10 shown in FIG. 2. The information processing apparatus 10 includes a CPU 10a, a nonvolatile memory 10b, a main memory 10c, a communication device 10d, an input device 10e, and a display device 10f.

The CPU 10a is a processor for controlling an operation of various components within the information processing apparatus 10. The CPU 10a may be a single processor or may be configured by a plurality of processors. The CPU 10a executes various programs loaded from the nonvolatile memory 10b into the main memory 10c. These programs include, for example, an operating system (OS), application programs, etc.

The nonvolatile memory 10b is a storage medium used as an auxiliary storage device. The main memory 10c is a storage medium used as a primary storage device. Although only the nonvolatile memory 10b and the main memory 10c are shown in FIG. 4, the information processing apparatus 10 may also include other storage devices (e.g., magnetic storage media, electromagnetic storage media, optical storage media, and semiconductor memory).

The communication device 10d is a device configured to execute communication with external devices. The input device 10e is a device enabling a user to perform various operations, including, for example, a mouse, a keyboard, a button, a panel switch, a slider switch, a trackball, a touch panel, a microphone, and a camera. Note that the input device 10e may also be, for example, a device configured to perform voice recognition or gesture recognition, or a device referred to as an eye tracker. The display device 10f is a device capable of displaying various screens, including, for example, a display.

Note that, in the present embodiment, some or all of the input support information creation module 11, the display processing module 12, the operation reception module 13, and the abstracted data creation module 14 included in the information processing apparatus 10 shown in FIG. 2 are realized by causing the CPU 10a (i.e., the computer of the information processing apparatus 10) to execute a predetermined program, that is, by software. This program may be stored on a computer-readable storage medium and distributed, or downloaded to the information processing apparatus 10 via a network. Note that some or all of the input support information creation module 11, the display processing module 12, the operation reception module 13, and the abstracted data creation module 14 may be realized by hardware such as an integrated circuit (IC), or by a combination of software and hardware.

Furthermore, the storage 15 shown in FIG. 2 is realized, for example, by the nonvolatile memory 10b or other storage devices.

Next, referring to the flowchart in FIG. 5, an example of a processing procedure of the information processing apparatus 10 according to the present embodiment will be described.

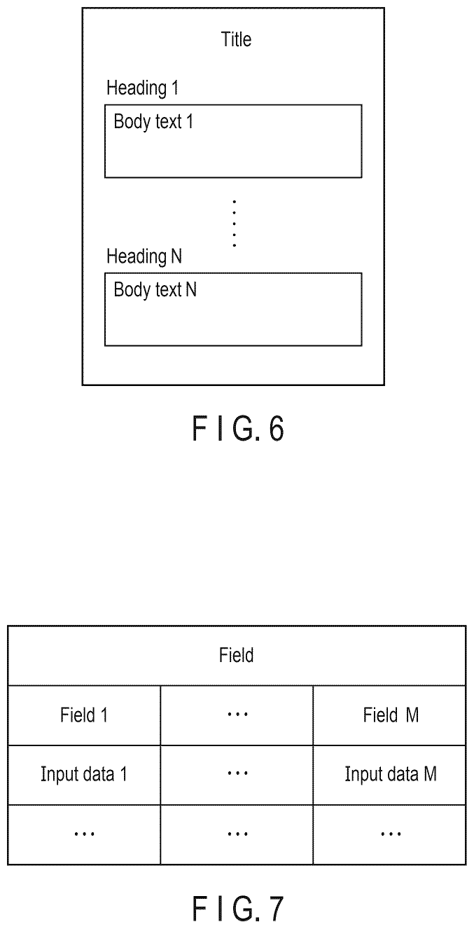

First, the input support information creation module 11 acquires reference data (step S1). Here, FIG. 6 shows an example of the reference data. The example shown in FIG. 6 assumes a case in which the reference data is document data. This reference data includes a title corresponding to a document name and a plurality of headings 1 to N (where N is an integer of two or greater) corresponding to sections.

Furthermore, each of the headings 1 to N included in the reference data has a body text (text) 1 to N written therein, respectively.

Note that, in the present embodiment, a case is assumed in which the reference data is visualizable (displayable) data. This reference data may be, for example, plain text, structured data, source code, image data (image files), and computer aided design (CAD) data, in addition to the aforementioned document data (document files). The reference data may also be data created by scanning or applying an optical character recognition/reader (OCR) to non-digitized documents, etc. or data in which speech is verbalized, which is created by performing speech recognition to speech data. Additionally, data-to-text or rendering processing may be executed on predetermined data to obtain visualizable reference data. For the sake of explanation, the following description will primarily focus on cases where the reference data is document data.

Returning to FIG. 5, the input candidate creation module 111 included in the input support information creation module 11 creates input candidates based on the reference data acquired in step S1 (step S2).

Here, as described above, input candidates are created by extracting portions of data (portions that serve as candidates for data that needs to be input to create abstracted data) from the reference data. This data extraction is realized by natural language processing such as morphological analysis or named entity extraction. Accordingly, input candidates can be created based on predetermined character strings (words, terms, named entities, etc.) described in, for example, the reference data (document data).

Furthermore, the data extraction may be realized using pattern matching, for example. Accordingly, input candidates can be created based on character strings (expressions) matching a predetermined pattern in the reference data, for example.

Note that the input candidates may be the data (a portion of the reference data) itself extracted from the reference data as described above; however, they may also be created, for example, by converting the content or format of the data. Specifically, for example, summaries or paraphrases of texts extracted as a portion of data from the reference data, created by executing natural language processing on the texts, may also serve as the input candidates. Furthermore, the input candidates may also be created using, for example, a list of character strings prepared in advance.

Also, in step S2, a plurality of input candidates may be created in some cases. However, for example, in a case where a plurality of identical character strings are extracted from the reference data, these plurality of identical character strings shall be treated as a single input candidate. Furthermore, referring to a synonym dictionary in which words with similar meanings to each other are registered, in a case where a plurality of character strings (words) that can be determined to have similar meanings are extracted, these multiple character strings may be treated as a single input candidate. That is, among the plurality of character strings with similar meanings, one character string may be converted into the other character string and used as an input candidate.

The explanation here assumes a case in which character strings equivalent to words are extracted. However, for example, in a case where a plurality of summaries are created from character strings (texts) extracted from the reference data, these summaries may be converted into predetermined specified features, and a plurality of summaries that can be determined to be semantically consistent (similar or duplicated) based on the degree of similarity of these features may be used as a single input candidate. Note that the determination of semantic consistency may be performed on the sentences themselves or on the words extracted from the reference data.

Here, an example is described in which a plurality of character strings extracted from the reference data are treated as a single input candidate. However, it is also acceptable to create input candidates that include, for example, a plurality of character strings with similar meanings (i.e., different expressions) listed together.

Next, the basis information creation module 112 creates basis information for the input candidates based on the reference data acquired in step S1 or the input candidates created in step S2 (step S3).

Here, the basis information is created, for example, by analyzing the description state of the input candidate (e.g., the character string in the document) in the reference data. In this case, the basis information includes, for example, a position where the input candidate is described in the reference data (hereinafter referred to as an input candidate description position), a context before and after the input candidate description position in the reference data (hereinafter referred to as a context before and after input candidate), or the number of times the input candidate is described in the reference data (hereinafter referred to as an input candidate description count).

The basis information may also be created based on classification results of the input candidates. Specifically, as described above, in a case where the input candidate is data extracted from the reference data via named entity extraction, that input candidate becomes a character string corresponding to a named entity. Named entities include, for example, organization names, personal names, place names, date expressions, time expressions, monetary expressions, and percentage expressions. Therefore, the input candidates can be classified into categories corresponding thereto. Therefore, in the present embodiment, the basis information may be created that includes the category to which the input candidate is classified (i.e., the classification result of the input candidate). Note that the classification of input candidates may be performed, for example, by referring to a classification dictionary prepared in advance. Furthermore, for example, a plurality of input candidates with high similarity calculated based on specified features converted from the input candidates may be classified into the same category.

Furthermore, the basis information may also be a numerical value calculated for each input candidate based on the analysis results of the description state of the input candidate in the aforementioned reference data or the classification results of that input candidate (i.e., information where the analysis results or classification results are quantified), etc. Such a numerical value calculated for each input candidate can be used as an estimated probability that the input candidate should be entered into the field (hereinafter referred to as an input candidate estimated probability). The input candidate estimated probability may be a value calculated by applying weighting (manually set coefficients) or a regression model trained on existing data.

When the processing of step S3 is executed, the display processing module 12 displays a screen for inputting data to create abstracted data (hereinafter referred to as a data input screen) on, for example, the display device 10f (step S4).

Here, as shown in FIG. 7, the abstracted data in the present embodiment has one or more fields (items) and a format where data is input into these fields. In other words, the abstracted data can be said to be data in a format that can be represented as a table. The example shown in FIG. 7 shows that the abstracted data has M fields from 1 to M.

The fields 1 to M of the abstracted data have definition information set in advance, such as the type of data that can be input into that field (hereinafter referred to as a data type). The data type includes, for example, text, numeric values, boolean values, dates, times, periods, coordinates, images, colors, persons, etc. Note that the fields 1 to M may be set with, for example, a data type that allows selection of one option from a list prepared in advance or a data type that specifies a predetermined order. Additionally, in the case of creating the abstracted data from a plurality of pieces of reference data, the data type may be an identifier of the reference data. Moreover, in the case of managing relationships with other abstracted data, the data type may be an identifier of the related abstracted data.

In a case where the abstracted data has the fields 1 to M as described above, the data input screen displayed in step S4 is provided with (areas for inputting data into) these fields 1 to M. The user can input data into each of these fields 1 to M via the data input screen.

In the present embodiment, for each of the fields 1 to M provided on such a data input screen, the input candidates created in step S2 and the basis information created in step S3 are displayed.

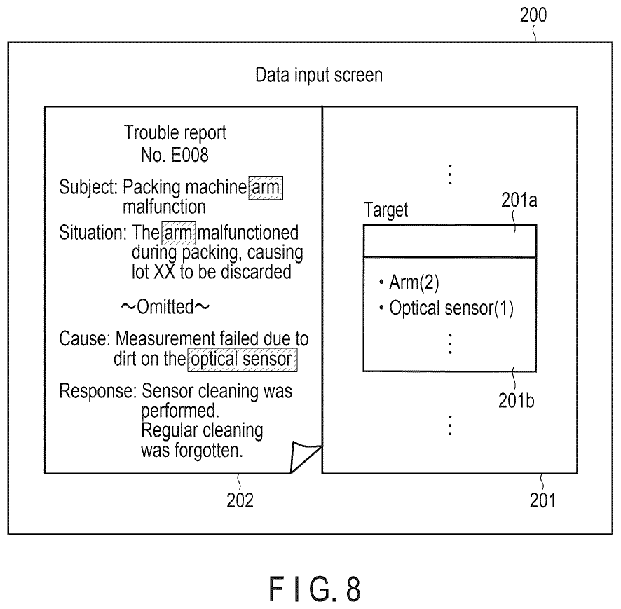

FIG. 8 shows an example of a data input screen. Here, the data input screen is described for a case in which a trouble case, which is abstracted data, is created from a trouble report, which is reference data.

As shown in FIG. 8, a data input screen 200 includes a data input area 201. In the data input area 201, although, for example, the aforementioned fields 1 to M are arranged, one field 201a among the fields 1 to M is shown.

Note that the field 201a is a field where a target of a matter reported in the trouble report is entered. This field 201a may be realized, for example, as a text box format allowing text input, or as a format where data selected from a pull-down menu, checkbox, or radio button is entered.

Here, a candidate area 201b corresponding to the field 201a is displayed within the data input area 201. The candidate area 201b is an area for displaying input candidates indicating candidates for the data to be entered into the field 201a. In the example shown in FIG. 8, the candidate area 201b displays “arm” and “optical sensor” as input candidates, which are character strings (e.g., words) extracted from the trouble report as described above.

In this case, a user operating the information processing apparatus 10 (i.e., a user performing abstraction tasks) can input data corresponding to the selected input candidate into the field 201a by selecting one of the input candidates displayed in the candidate area 201b, for example. Note that the input candidate may be selected using, for example, a pull-down menu, checkbox, or radio button.

Note that, as described above, in a case where input candidates are created in a manner that includes a plurality of character strings listed together, the candidate area 201b may display these plurality of character strings in a format where they are separated by predetermined characters or symbols. The input candidates may also be displayed in a format representing a predetermined relationship between the plurality of character strings.

As described above, by selecting the input candidate, the user can input data corresponding to the selected input candidate into the field 201a. However, in a case where a plurality of input candidates are displayed in the candidate area 201b, it may be difficult for the user to determine appropriate data among these plurality of input candidates.

Therefore, on the data input screen 200, basis information for the input candidates is additionally displayed to assist the user in making the aforementioned decisions.

Specifically, in the candidate area 201b, a numerical value is displayed as basis information in association with each input candidate. This numerical value represents the input candidate description count in the trouble report, which is the reference data. In the example shown in FIG. 8, it indicates that the term “arm” appears twice and the term “optical sensor” appears once in the trouble report. Note that, in a case where the trouble report includes body text corresponding to a plurality of headings (sections) as shown in FIG. 6, the input candidate description count may be counted for each heading.

Additionally, the data input screen 200 further includes a document display area 202. The document display area 202 displays a trouble report (reference data) that is referenced to create a trouble case (abstracted data). Specifically, the document display area 202 displays the trouble report with each input candidate (here, “arm” and “optical sensor”) highlighted. Based on the trouble report displayed in this document display area 202, the user can grasp the input candidate description position within the trouble report and the context before and after the input candidate, etc. as the basis information for the input candidate.

In the present embodiment, by referring to the basis information for the input candidates described above, the user can select an appropriate input candidate.

Note that, although omitted in FIG. 8, other basis information may also be displayed on the data input screen 200. Specifically, for example, in the candidate area 201b, the classification result of an input candidate may be displayed as the basis information for that input candidate. In this case, for example, in the candidate area 201b, input candidates classified into the same category may be displayed with the same color applied, or a category name into which the input candidate was classified may be displayed in association with that input candidate. Furthermore, the estimated probability calculated based on the aforementioned input candidate description count, description position, and classification result may be displayed as basis information for that input candidate.

Furthermore, here, while the input candidates are described as being displayed in the candidate area 201b, the input candidates displayed in the candidate area 201b may be narrowed down based on the basis information. Specifically, the candidate area 201b may display only input candidates whose description count is above or equal to a threshold value, for example.

Furthermore, the candidate area 201b may display only input candidates classified into categories corresponding to the data type set in the field 201a (i.e., candidates for data of that data type extracted from the reference data).

Furthermore, as described above, in a case where the trouble report includes body text corresponding respectively to a plurality of headings (sections), the candidate area 201b corresponding to the field 201a may display only input candidates extracted from the body text corresponding to a specific heading that is set in advance for that field 201a. In addition, in the present embodiment, the layout and structure of the trouble report may be analyzed to create input candidates narrowed down according to the context before and after.

Furthermore, in a case where a plurality of input candidates are displayed in the candidate area 201b, these input candidates may be displayed according to the priority set for the input candidate. Note that the priority may be set based on the estimated probability of the input candidate, etc. as described above.

Furthermore, in the case of displaying the input candidate description position in the trouble report as the basis information, the input candidate may be displayed (represented) by changing its character color, background color, etc., from the other character strings. The input candidate may be displayed to be distinguishable from other character strings by applying features such as borders, underlines, arrows, bold text, or blinking.

Furthermore, the input candidates in the trouble report may be processed according to, for example, the category into which the input candidate is classified or the degree of similarity with other input candidates. In this case, input candidates belonging to the same category or having high similarity may be assigned the same color or similar colors.

Additionally, the estimated probability, etc. of the input candidate may be expressed by changing the brightness, saturation, or thickness of the underline, etc. of the input candidate.

Furthermore, here, while a case is assumed where the entire trouble report is displayed in the document display area 202, only a portion of the trouble report (e.g., a part related to input candidates or basis information, or surrounding portions) may be displayed in the document display area 202.

In addition, to improve the visibility of the data input screen 200 or the operability of data input into the data input screen 200 (field 201a), the display of the document display area 202 described above may be toggled on and off.

Furthermore, the data input screen 200 may be displayed, for example, in a split view, or using a pop-up, a separate screen, etc. Also, the display mode of the data input screen 200 may be switchable between a plurality of patterns prepared in advance.

Returning to FIG. 5, the user can input data (i.e., data corresponding to the selected input candidate) into a field by selecting an input candidate displayed in the candidate area corresponding to that field on the data input screen (data input area) displayed in step S4 using the input device 10e. Note that, for example, the input candidate with the highest estimated probability may be entered into the field by default. Furthermore, the data entered into the field may be a single input candidate selected from a plurality of candidates, or may be two or more input candidates separated by predetermined characters or symbols.

The abstracted data creation module 14 creates abstracted data based on the data entered into each field on the data input screen (step S5). Note that the abstracted data created in step S5 corresponds to data obtained by abstracting the reference data and has a data structure that includes the data entered into each of the aforementioned fields in association with each other.

When the processing of step S5 is executed, the abstracted data created in that step S5 is stored in the storage 15 (step S6).

Note that the processing of steps S5 and S6 may be executed in a case where, after the data input screen is displayed in step S4 and data is entered into all fields of the abstracted data, the user instructs the creation and storage (saving) of the abstracted data.

In the present embodiment, by executing the processing of steps S1 to S6 each time reference data is created, for example, an abstracted database is constructed where abstracted data created from the reference data is accumulated.

As described above, in the case of performing the abstraction task to create abstracted data that is abstracted from reference data, the information processing apparatus 10 according to the present embodiment creates input candidates (candidates for data that needs to be input to create abstracted data) based on the reference data, creates basis information (basis information representing the basis for which the input candidates should be input to create abstracted data) for the input candidates, and outputs the created input candidates and basis information.

Note that, in the present embodiment, it is assumed that the input candidates and basis information are displayed on the display device 10f; however, these input candidates and basis information need only be output in a manner to be presented to the user.

In the present embodiment, such a configuration makes it possible to assist the user in performing the abstraction task (data input for creating abstracted data). Specifically, the user only needs to perform an operation such as selecting an input candidate created based on the reference data, and can be saved the trouble of searching for a relevant section from the reference data. Furthermore, since the user can refer to the basis information when selecting an input candidate, it becomes easier to make a decision regarding that selection.

Furthermore, in the present embodiment, the reference data need not be created in a format set in advance (i.e., it may be created in any format), which makes it possible to reduce the burden of creating such reference data.

Furthermore, in a case where, for example, an input candidate created based on the reference data is inappropriate, the user can modify or correct (i.e., rewrite) that input candidate before inputting it, or input data that is different from the input candidate. Note that “input candidate is inappropriate” includes cases where the input candidate is intended to be changed by the user.

That is, in the present embodiment, by outputting (presenting to the user) input candidates and the basis information for those input candidates, the burden on the user in deciding whether to input or modify data for creating abstracted data can be reduced. Furthermore, in the present embodiment, even in a case where the quality of reference data is low, it is possible to perform the abstraction task (creation of abstracted data) while verifying the validity of the data to be input for creating abstracted data. This enables improvement in the quality of the abstracted data. Additionally, in the present embodiment, even in a case where the user performing the abstraction task lacks sufficient skill, it is possible to reduce the time required for the abstraction task.

Note that the abstracted data in the present embodiment is created by inputting data into a field that the abstracted data has. The input candidates, however, are created based on a portion of data extracted from the reference data based on definition information (e. g., data type) of data that can be input into the field. The input candidates presented to the user may also be created by narrowing down a plurality of pieces of data extracted from the reference data based on, for example, the basis information. Such a configuration can avoid presenting unnecessary or inappropriate input candidates to the user and reduce the burden on the user in selecting the input candidates.

In the present embodiment, input candidates are described as being created based on a portion of data extracted from the reference data. However, these input candidates may also be created, for example, by converting the portion of data extracted from the reference data. With this configuration, it may be possible to create and present to the user input candidates that are more appropriate than a portion of data simply extracted from the reference data. Furthermore, with this configuration, it is possible to reduce the time required to consider variations in notation, etc. during the abstraction.

Furthermore, in the present embodiment, it is possible to create basis information that includes, for example, the position or number of times the input candidate appears in the reference data. With this configuration, the user can perform the abstraction task while grasping the correspondence between the reference data and the input candidates.

Furthermore, the basis information may be created based on the category into which the input candidate is classified. Note that the classification of input candidates may be performed based on, for example, the degree of similarity between the input candidates. In the present embodiment, by presenting such basis information to the user, the user can easily select an input candidate (i.e., input candidate selection by the user is assisted).

In the present embodiment, abstracted data is created, in which data is input according to a user's operation on the data input screen that displays input support information (input candidates and basis information). However, the present embodiment may also be configured (hereinafter referred to as a first modified example of the present embodiment) to create input support information based on a state that occurs in conjunction with the user's operation (hereinafter referred to as an input state).

Note that the user's operation assumed in the first modified example of the present embodiment is an operation that the user can perform using the input device 10e. This operation may be, for example, moving coordinates on the data input screen or clicking operations (e.g., selecting an input candidate) using a pointing device, or pressing a predetermined key on a keyboard (e.g., entering a character string into a field). Furthermore, the input state described above includes, for example, a state where data is input into a field.

In this case, for example, in the first modified example of the present embodiment, it may be considered to create basis information for input candidates of a second field different from the first field based on data (input data) input into the first field of the abstract data. Specifically, for example, by analyzing the relationship between the input candidate (the input candidate for the second field) displayed in a candidate area corresponding to the second field of the abstracted data and the data already entered in the first field, basis information including the analysis results may be created. Note that, in a case where the analysis is performed using a dictionary in which co-occurrence relationships prepared in advance is defined, basis information indicating the co-occurrence relationship between the data entered in the first field and the input candidate can be created. According to this configuration, for example, the user can easily select input candidates that have a co-occurrence relationship with the already entered data.

Note that, in the first modified example of the present embodiment, for example, analysis may be performed on data entered into a field (already entered data), and basis information related to the validity of that data (i.e., the necessity to change or correct that data) may be created. The analysis in this case may be performed on the data entered into the field alone, or may be performed on that data and other data (reference data or data entered into other fields). According to this, for example, by creating basis information that includes the position or number of times that the data entered into the field appears in the reference data, the user can grasp that, in a case where the data entered into the field does not appear in the reference data, the data may be not be valid.

Note that, in the first modified example of the present embodiment, the degree of conformity between the data already entered into the field and the reference data may be displayed. In a case where the degree of conformity is low, the user may be notified that correction is necessary, for example, by applying a predetermined color or icon to the field.

Here, a state in which data is entered into a field has been mainly described as an example of the input state; however, the input state may also be, for example, a state in which a cursor is at a predetermined position, a state in which a field intended for data entry is selected (field focus state), a state in which the cursor is superimposed over an input candidate (hover state), or a state in which a checkbox prepared in advance is selected (checked state). In such cases, it becomes possible, for example, to create and display input candidates for a field and basis information for the input candidates only in a case where that field is selected based on the field focus state. Furthermore, since displaying basis information for all input candidates could make verifying the basis information cumbersome, only the basis information for the input candidates in the hover state may be displayed. Alternatively, only the basis information for the selected input candidate or the data entered into the field may be displayed. In other words, in the first modified example of the present embodiment, for example, the content of the data input screen may be created and displayed according to the input state (i.e., the input candidates and basis information are change according to the user's operation).

Also, in the first modified example of the present embodiment, the basis information may be created and displayed in a case where an operation instructing the creation and storage of abstracted data is performed after data is entered into a field (i.e., an abstracted data save event occurs). Furthermore, in the first modification of the present embodiment, in a case where an operation instructing to cancel the creation and storage of the abstracted data is performed (i.e., an abstracted data cancellation event occurs), for example, the processing of creating and displaying input candidates and basis information according to the updated input state may be repeated.

Here, in the present embodiment, the abstracted data created from the reference data is stored in the storage 15 (accumulated in the abstracted database). However, the present embodiment may also be configured to create input support information based on past abstracted data (i.e., abstracted data created in the past) accumulated in the abstracted database (hereinafter referred to as a second modified example of the present embodiment).

In this case, in the second modified example of the present embodiment, for example, data entered into fields in past abstracted data accumulated in the abstracted database (existing data in the fields) can be utilized as input candidates (i.e., presented to the user). Furthermore, in the second modified example of the present embodiment, among input candidates created based on reference data, only input candidates that match data entered into fields in past abstracted data may be presented.

Here, in the present embodiment, it has been explained that the input candidate with the highest estimated probability may be entered into the field by default. However, for example, data (input candidate) entered into a field of a single piece of past abstracted data may also be entered into the field by default. In a case where a predetermined input candidate is entered into the field by default as described above, since, for example, abstracted data can be created with only minimal changes to fields with low degree of conformity as described above, the work time and burden on the user can be reduced.

Furthermore, in the second modified example of the present embodiment, basis information may be created that includes, for example, whether or not input candidates are entered into fields of past abstract data (i.e., the presence or absence of input candidates in the abstract database) or the number of input candidates entered into the field (the number of appearances).

The basis information may also be created based on co-occurrence relationships between a plurality of fields of past abstract data. Specifically, the basis information indicating combinations of input candidates that have co-occurrence relationships among the plurality of fields of the past abstracted data may be created.

Note that, in a case where input support information (input candidates and basis information) is created based on past abstracted data, the past abstracted data used to create the input support information may be displayed as part of the basis information on the aforementioned data input screen.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is

1. An information processing apparatus configured to assist abstraction tasks for creating abstracted data from reference data, comprising a processor configured to:
create input candidates indicating candidates for data that needs to be input to create the abstracted data based on the reference data;
create basis information representing basis for which the input candidates should be input to create the abstracted data based on the reference data; and
output the input candidates and the basis information.

2. The information processing apparatus of claim 1, wherein
the abstracted data is created by inputting data into fields possessed by the abstracted data, and
the processor is configured to create the input candidates based on a portion of data extracted from the reference data based on definition information of data that can be input into the fields.

3. The information processing apparatus of claim 2, wherein
the input candidates are created by converting a portion of the data extracted from the reference data.

4. The information processing apparatus of claim 1, wherein
the processor is configured to create basis information including a position or number of times at which the input candidates appear in the reference data.

5. The information processing apparatus of claim 1, wherein
the abstracted data is created by inputting data into the fields possessed by the abstracted data, and
the processor is configured to create basis information including a position or number of times at which data input into the fields appear in the reference data.

6. The information processing apparatus of claim 1, wherein
the abstracted data is created by inputting data into first and second fields possessed by the abstracted data, and
the processor is configured to create basis information representing basis for which the input candidates should be input into the second field based on data input into the first field.

7. The information processing apparatus of claim 6, wherein
the basis information is created based on data input into first and second fields possessed by abstracted data created in the past.

8. The information processing apparatus of claim 1, wherein
the processor is configured to create the basis information based on a category into which the input candidates are classified.

9. The information processing apparatus of claim 1, wherein
the input candidates are narrowed down based on the created basis information.

10. The information processing apparatus of claim 1, wherein
the processor is configured to display the input candidates and the basis information on a display device.

11. The information processing apparatus of claim 1, wherein
the input candidates and the basis information are changed in response to user operation.

12. The information processing apparatus of claim 1, further comprising a storage, wherein
the processor is configured to create abstracted data based on the input candidates entered in response to user operation; and
the storage is configured to store the abstracted data.

13. An information processing method executed by an information processing apparatus configured to assist abstraction tasks for creating abstracted data from reference data, comprising:
creating input candidates indicating candidates for data that needs to be input to create the abstracted data based on the reference data;
creating basis information representing basis for which the input candidates should be input to create the abstracted data; and
outputting the input candidates and the basis information.

14. A non-transitory computer-readable storage medium having stored thereon a program which is executed by a computer of an information processing apparatus configured to assist abstraction tasks for creating abstracted data from reference data, the program comprising instructions capable of causing the computer to execute functions of:
creating input candidates indicating candidates for data that needs to be input to create the abstracted data based on the reference data;
creating basis information representing basis for which the input candidates should be input to create the abstracted data based on the reference data; and
outputting the input candidates and the basis information.
